(19) United States
(12) Patent Application Publication
(10) Pub. No.: US 2017/0024754 A1
(43) Pub. Date: Jan. 26, 2017

(54) Method of Negotiating Prices and Distributing for Products and Services

(71) Applicant: Shrikant U. Janolkar, San Jose, CA (US)

(72) Inventor: Shrikant U. Janolkar, San Jose, CA (US)

(21) Appl. No.: 15/217,960

(22) Filed: Jul. 22, 2016

Related U.S. Application Data
(60) Provisional application No. 62/195,389, filed on Jul. 22, 2015.

(51) Int. Cl. G06Q 30/02; G06Q 30/06; G06Q 50/18

(52) U.S. Cl. CPC G06Q 30/0206; G06Q 50/188; G06Q 30/0611; G06Q 30/0214

(57) ABSTRACT

A method of negotiating prices and distributing products and services manages a product transaction between a plurality of buyer accounts and a seller account. The buyer accounts and the seller account are managed by a remote server. Through corresponding personal computing devices, the buyer accounts are able to submit a future product demand notification to the seller account. The seller account is able to submit an array of quoted prices in accordance to the future product demand received. After receiving negotiation feedback from the buyer accounts, the seller then adjusts the array of quoted prices. The process repeats until the buyer accounts and the seller account agree on a final price point. A monetary transaction is managed by the remote server between the core buyer accounts of the buyer accounts and the seller account. The product demand is then sent to the buyer accounts to receive the product as needed.

The current application claims a priority to the U.S. Provisional Patent application Ser. No. 62/195,389 filed on Jul. 22, 2015.

### FIELD OF THE INVENTION

The present invention relates generally to a method for price negotiation and distribution for a product. More specifically, the present invention relates to a method to receive input from a buyer account and a seller account in order to dynamically negotiate a product price point.

### BACKGROUND OF THE INVENTION

Commercial business at the most basic level involves the trade of goods and/or services for payment between a buyer and a seller. Prices for goods take many factors into consideration such as the cost of manufacturing, operations, product quality, and the targeted market. Accurately and fairly pricing a product or service can be a complicated and uncertain process. Previous market demand and performance of similar products can provide some insight into how well a product will sell or perform in the same market. Previous product pricing is also taken into consideration along with the market demand and performance of the product; however, there is generally no way to accurately predict the actual market performance of a new product. As a result, a seller or supplier will set a product price based on an assumption of market performance due to the uncertainty surrounding the product's ability to sell. There is generally no prior interaction between buyers and sellers in order to gauge potential market demand for products, particularly for new products or services. As a result, the transaction process becomes one-sided, with static prices that do not take into consideration the needs of the buyers. The present invention seeks to enhance and improve upon the conventional transaction process between buyers and sellers by maximizing transparency in terms of product and service pricing.

The present invention is a method through which sellers are able to set pricing for products or services based on a negotiation process with a targeted buyer market. The present invention maximizes the pricing of a product or service based on the product's actual value as well as reliable projection of buyer demand based on a dynamic negotiation process between seller and buyer. As a result, sellers and suppliers are able to offer products or services that are fairly priced to maximize benefits to both the sellers/suppliers and the buyers. The present invention focuses on maximizing the transparency of all aspects of the bulk order transaction process, particularly regarding pricing. Sellers and suppliers rely on open communication with the targeted market for a product or service that requires pricing. The targeted market is consolidated in terms of numbers into a core group of buyers. This allows sellers and suppliers to enter into a dynamic negotiation process with the core group of buyers in order to gauge potential market performance of the product in question. Based on information drawn from the negotiation process with the core group of buyers as well as from other factors such as market performance of similar products, the sellers and suppliers are able to set a fair price for the product. The price of the product is based on a set of transaction terms that are agreed upon by all parties during the negotiation process. This process provides a more reliable and accurate means of pricing products than pricing products solely based on an assumption of product performance.

### BRIEF DESCRIPTION OF THE DRAWINGS

FIG. 1 is a box diagram showing how the corresponding PC devices for buyer accounts, the seller account, the social seller accounts, and the social expert accounts are managed by the remote server.

FIG. 2 is a flow diagram showing the general steps of the present invention.

FIG. 3 is a flow diagram of the present invention including a product database, inversely reducing the final price point according to the quantity of buyers, and generating a shipping order for the future product demand.

FIG. 4 is a flow diagram depicting the referral and incentive process for a patron account of the plurality of buyer accounts to bring in a new account into the present invention.

FIG. 5 is a flow diagram of the present invention including a plurality of bystanding buyer accounts.

FIG. 6 is a flow diagram of the present invention including a plurality of social seller accounts.

FIG. 7 is a flow diagram depicting the referral and incentive process for a patron account of the social seller accounts to bring in a new account into the present invention.

FIG. 8 is a flow diagram showing the rating process for the social seller accounts by the core buyer accounts.

FIG. 9 is a flow diagram of the present invention including a plurality of social expert accounts.

FIG. 10 is a flow diagram showing the rating process for the social expert accounts by the core buyer accounts and the seller account.

FIG. 11 is a flow diagram depicting the monitoring of the monetary transaction in order to generate product analytics.

FIG. 12 is a flow diagram of the present invention, wherein the buyer accounts are automated.

FIG. 13 is a flow diagram of the present invention, wherein the seller accounts are automated.

FIG. 14 is a flow diagram of the present invention, wherein the bystanding buyer accounts are automated.

FIG. 15 is a flow diagram of the present invention, wherein the social seller accounts are automated.

### DETAIL DESCRIPTIONS OF THE INVENTION

All illustrations of the drawings are for the purpose of describing selected versions of the present invention and are not intended to limit the scope of the present invention.

The present invention is a method of negotiating prices and distributing for products and services. The present invention seeks to increase transparency for transactions between buyers and sellers for products and services. The present invention maximizes the pricing of a product or service based on the product's actual value as well as reliable projection of buyer demand based on a dynamic negotiation process between seller and buyer. The negotiation process determines the quantity and price per unit for a product to be distributed to the buyer.

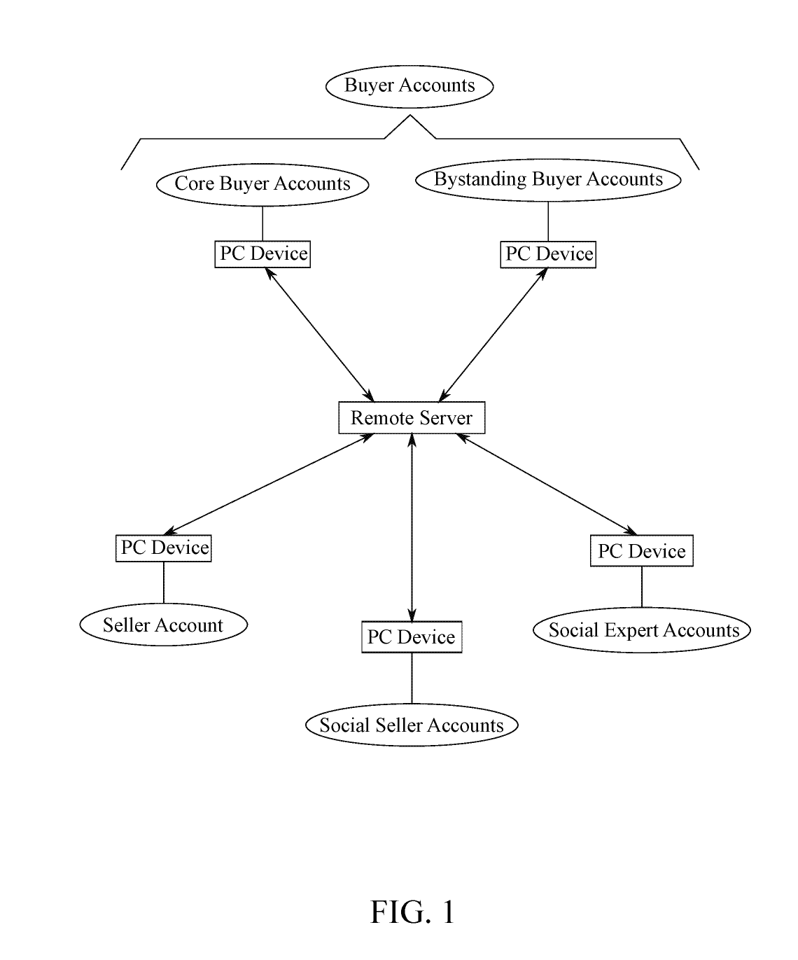

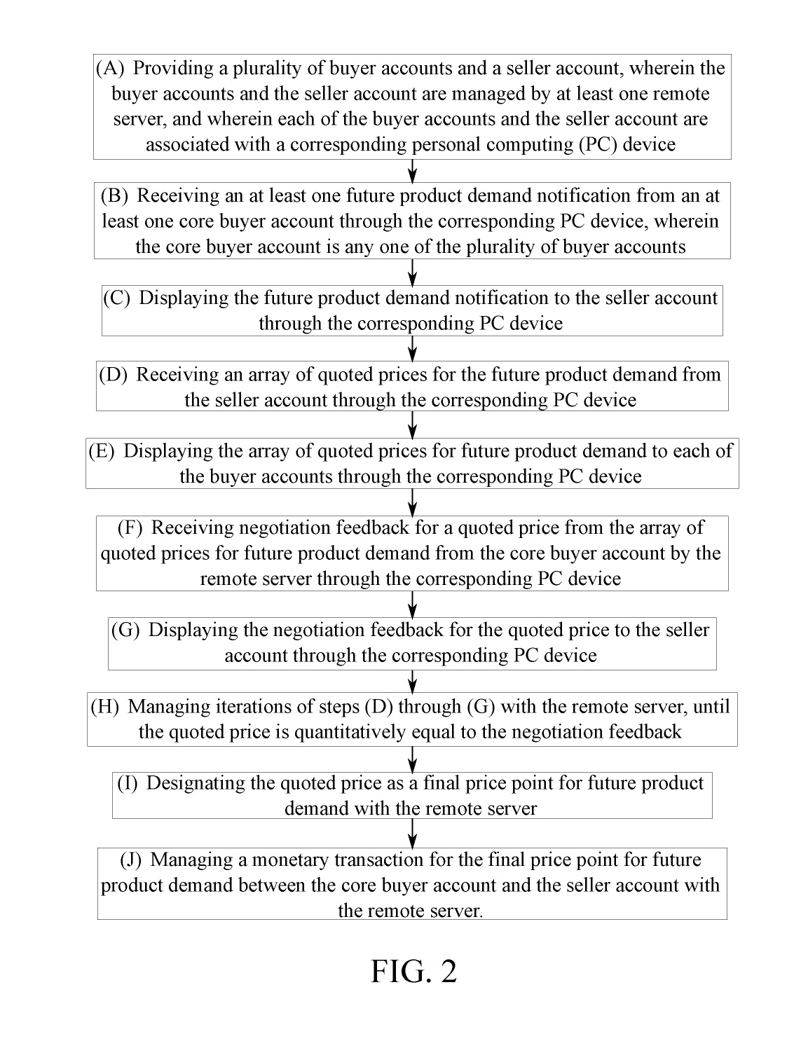

In accordance to FIG. 1, the present invention requires a plurality of buyer accounts and a seller account, wherein the buyer accounts and the seller account are managed by at least one remote server and wherein each of the buyer accounts and the seller account are associated with a corresponding personal computing (PC) device (Step A), as shown in FIG. 2. The users of the plurality of buyer accounts are a group of businesses which expresses a demand for a product to a distributer ahead of selling out of the product. The seller account is a distributer or manufacturer of the product. The corresponding PC device for each of the buyer accounts and the seller account are communicatively coupled to at least one remote server, in order for the remote server to receive, processes, and distribute information between each of the buyer accounts and the seller account.

Initial to the present invention, an at least one future product demand notification is received from an at least one core buyer through the corresponding PC device, wherein the core buyer account is any one of the plurality of buyer accounts (Step B). The future product demand notification is a statement for the amount of product that the at least one core buyer requests to receive through the transaction. The core buyer account is used to initiate and negotiate with the seller account for the quantity of product demanded. The future product demand notification is then displayed to the seller account through the corresponding PC device (Step C), in order for seller account to assign a price per unit to the future product demand. An array of quoted is received for the future product demand from the seller account through the corresponding PC device (Step D), in order to provide a table of prices per quantity to the plurality of buyer accounts. The array of quoted prices for future product demand is displayed to each of the buyer accounts through the corresponding PC device (Step E), in order the buyer account to make an informed decision to purchase a quantity of the product at the provided price or to provide negotiation feedback to the seller to adjust the price to be more favorable to the plurality of buyers. Negotiation feedback for a quoted price from the array of quoted prices for future product demand from the core buyer account is received by the remote server through the corresponding PC device (Step F). The negotiation feedback provides an input from the core buyer account as a reference price for the value of the future product demand for the consideration of the seller account to reevaluate the array of quoted prices. The negotiation feedback for the quoted price is displayed to the seller account through the corresponding PC device (Step G).

Iterations of Step D through Step G are managed with the remote server until the quoted price is quantitatively equal to negotiation feedback (Step H), such that the core buyer account and the seller account are able to come to an agreement for the worth of the future product demand. As the core buyer account and the seller account agree on the quoted price, the quoted price is then designated as a final price point for future product demand with the remote server (Step I). A monetary transaction for the final price point for future product demand is managed between the core buyer account and the seller account with the remote server (Step J), in order for the core buyer to transfer payment to the seller account. Once the monetary transaction is complete, a shipping order for the future product demand is generated with the remote server after Step J, in order to distribute the future product demand to the core buyer account when the core buyer account authorizes the shipping of the future product demand. Therefore, the core buyer account is able to receive the future product demand as needed.

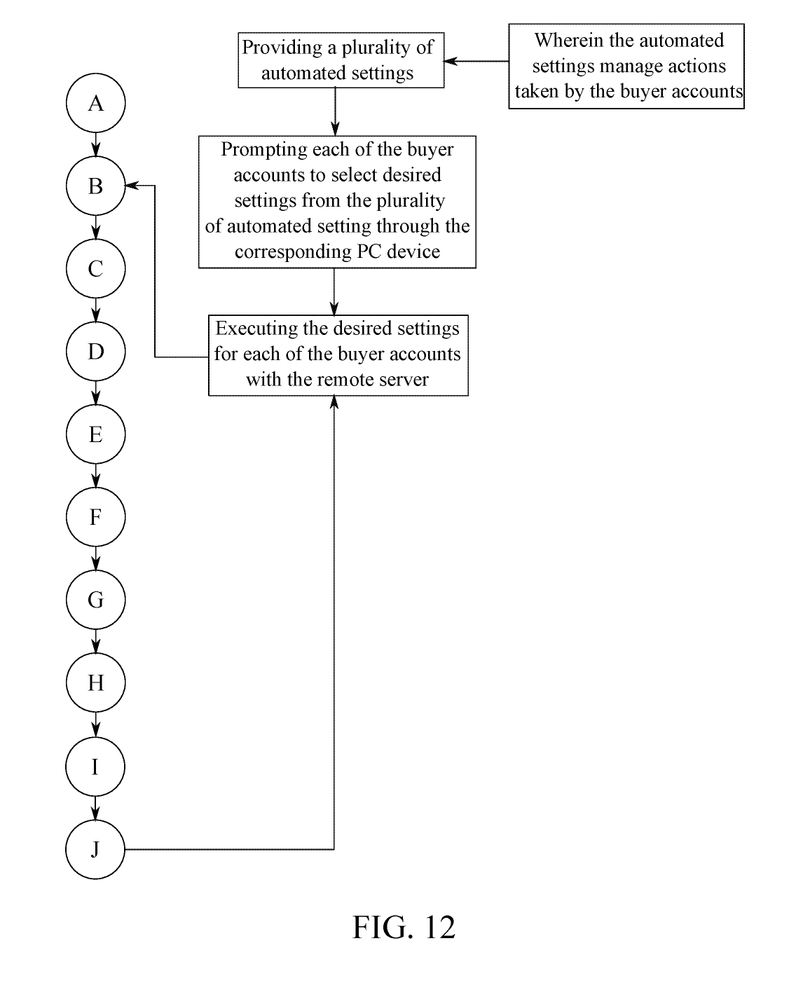

In accordance to the preferred embodiment of the present invention, the present invention includes a plurality of automated settings. As shown in FIG. 12, the automated settings allow users of the buyer accounts to manage the purchasing transaction through the use of a dynamic artificial intelligence. The automated settings manage actions taken by the buyer accounts during Step B through Step J. Each of the buyer accounts is prompted to select desired settings from the plurality of automated setting through the corresponding PC device. The desired settings include, but are not limited to, recording transaction history, recording product metadata, and price thresholds for purchasing products. The desired settings are executed for each of the buyer accounts with the remote server during Steps B through Step J. The execution of the desired settings promotes products and similar products that the user bought through previous transactions or previously viewed the through the recorded metadata. The price threshold is a value received by the remote server for the negotiation feedback during Step F, such that the transaction is completed if the quoted price is equal to or less than the price threshold. The price threshold is dynamically dependent on the transaction history and the quoted prices in order to be most profitable to the user of the buyer accounts.

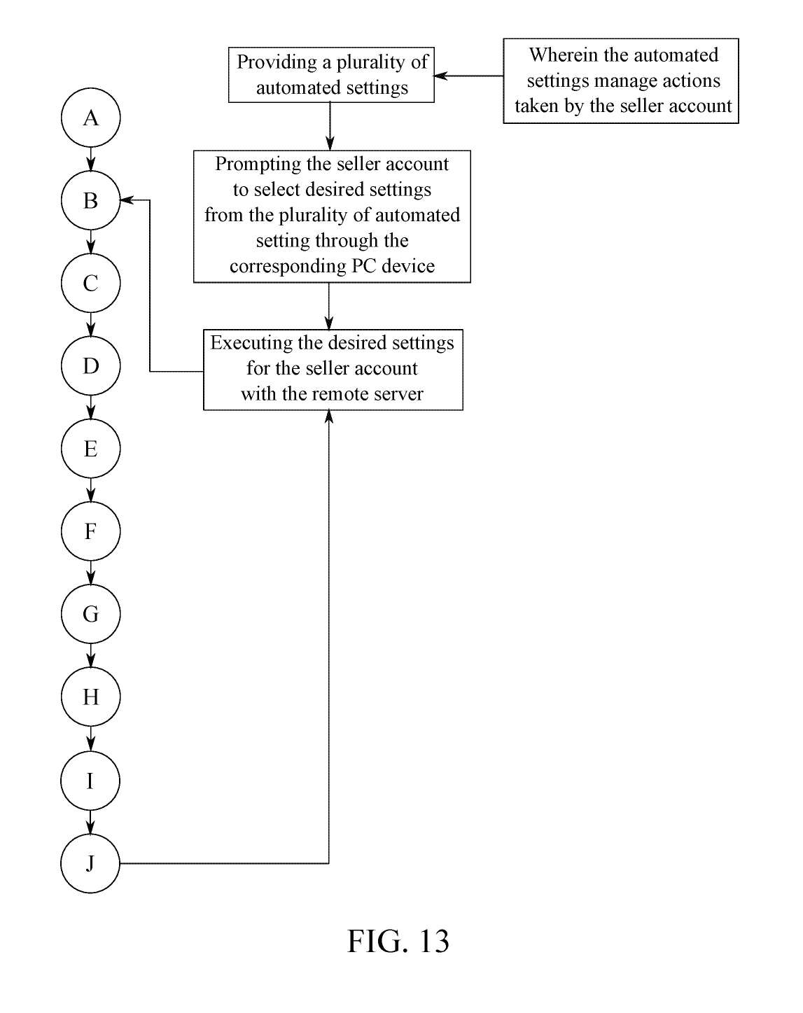

Similarly, the automated settings allow users of the seller account to manage the purchasing transaction through the use of a dynamic artificial intelligence, in accordance to FIG. 13. The automated settings manage actions taken by the seller account during Step B through Step J. The seller account is prompted to select desired settings from the plurality of automated setting through the corresponding PC device. The desired settings include, but are not limited to, recording transaction history, recording product metadata, and price thresholds for selling products. The desired settings are executed for the seller accounts with the remote server during Steps B through Step J. The execution of the desired settings promotes products and similar products that the user bought through previous transactions or previously viewed the through the recorded metadata. The price threshold is a value received by the remote server for the quoted price during Step F, such that the transaction is completed if the negotiation feedback is equal to or greater than the price threshold. The price threshold is dynamically dependent on the transaction history and the negotiation feedback in order to be most profitable to the user of the seller account.

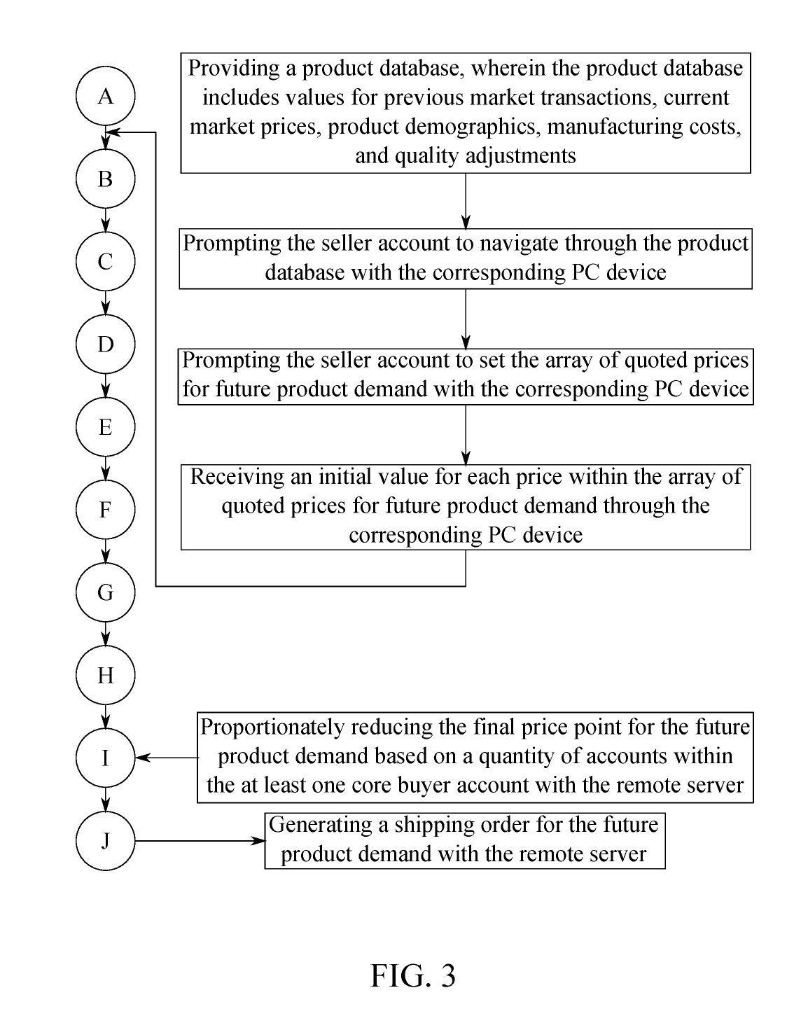

In accordance to the preferred embodiment of the present invention, a product database is further required, wherein the product database includes values for previous market transactions, current market prices, product demographics, manufacturing costs, and quality adjustments. The product database allows for the array of quoted prices to be scaled due to a number of factors reflected in the quality and demand for the product. As shown in FIG. 3, the seller account is prompted to navigate through the product database with the corresponding PC device, in order to access the information of the product database to more accurately select values for the array of quoted prices for the future product demand. Subsequently, the seller account is prompted to set the array of quoted prices for future product demand with the corresponding PC device. Therefore, an initial value for each price within the array of quoted prices for future product demand is received through the corresponding PC device before Step B, such that the competitive prices are determined before being displayed to the buyer accounts reducing negotiation time between the buyer accounts and the seller account.

In some embodiments of the present invention, the final price point for the future product demand is proportionately reduced based on the quantity of accounts within the at least one core buyer account with the remote server, during Step I. Adjusting the final price point inversely to the quantity of accounts within the at least one core buyer account drives the price down as the quantity of accounts increases. The reduced final price point provides an incentive to the core buyers to bring in additional new buyer accounts.

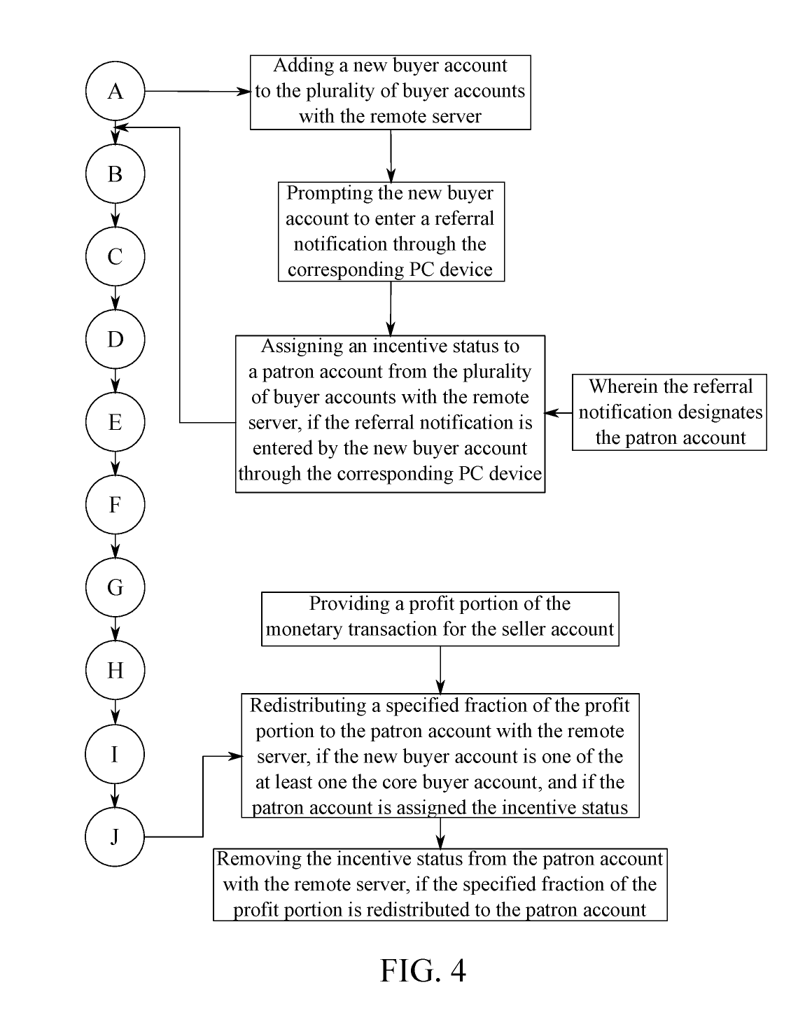

In accordance to the preferred embodiment of the present invention, a new buyer account is added to the plurality of buyer accounts with the remote server during Step A, as detailed in FIG. 4. A new buyer account may participate in the actions of a core buyer account immediately as in Step B through Step J. The new buyer account is prompted to enter a referral notification through the corresponding PC device. The referral notification indicates a patron account which directed the new buyer account to the services provided by the present invention. An incentive status is then assigned to the patron account from the plurality of buyer accounts with the remote server, if the referral notice is entered by the new buyer through the corresponding PC device, wherein the referral notice designates the patron account. If the incentive status is assigned to the patron account, the patron account is eligible to receive compensation for bringing new accounts into the present invention during the monetary transaction.

In some embodiments of the present invention, a profit portion of the monetary transaction for the seller account is designated by the present invention in order to determine compensation for the patron account. A specified fraction of the profit portion is redistributed to the patron account with the remote server during Step J, if the new buyer account is one of the at least one core buyer account and if the patron account is assigned the incentive status. Therefore, the patron account receives compensation for bringing a new buyer account into the core buyer accounts, if the new account designates the patron account. Subsequently, the incentive status for the patron account is removed with the remote server, if the specified fraction of the profit portion is redistributed to the patron account. The incentive status is removed for the patron account as an indication that the patron account has been compensated for bringing the new account into the present invention.

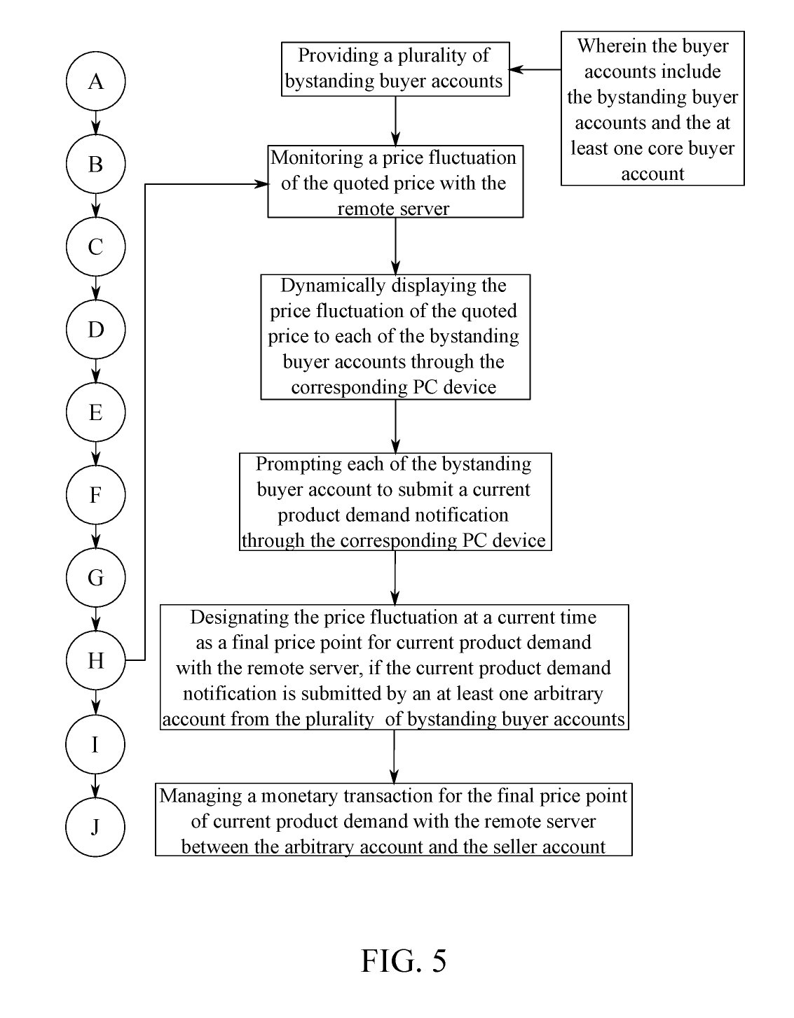

In some embodiments of the present invention, a plurality of bystanding buyer accounts is provided, wherein the buyer accounts include the bystanding buyer accounts and at least one core buyer account. The bystanding buyer accounts are able to view the outcome for Step H and make informed purchasing decisions for the product during Step H. The users of the bystanding buyer accounts are able to view the negotiation between in order to establish immediate or future transactions with the seller account. In accordance to FIG. 5, a price fluctuation of the quoted price is monitored with the remote server during Step H. The price fluctuation is the change in quoted price between a previous iteration of Step H and a current iteration of Step H. The price fluctuation of the quoted price is dynamically displayed to each of the bystanding buyer accounts through the corresponding PC devices. Each of the bystanding buyer accounts is prompted to submit a current product demand notification through the corresponding PC device in order to acquire the current product demand at the price point presented. The current product demand is a statement for the amount of product that the bystanding buyer accounts requests to receive through the transaction. The price fluctuation at a current time is designated as the final price point for the current product demand with the remote server, if the current product demand is submitted by an at least one arbitrary account from the plurality of bystanding buyer accounts. The current time corresponds to the time which the arbitrary account submits the current product demand and the final price point for the current product demand is the negotiation price for the iteration of the price fluctuation at the current time. Subsequently, a monetary transaction for the final price point of current product demand is managed with the remote server between the arbitrary account and the seller account.

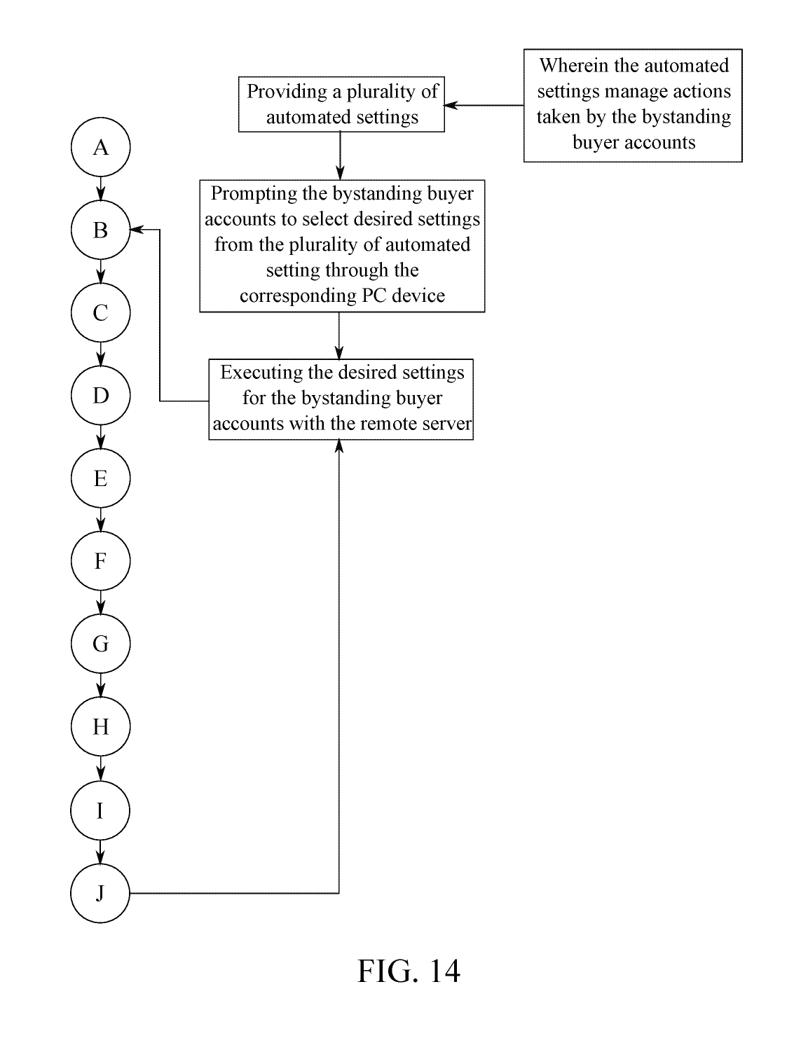

Similar to the buyer accounts, the automated settings allow users of the bystanding buyer accounts to manage the purchasing transaction through the use of a dynamic artificial intelligence, in accordance to FIG. 14. The automated settings manage actions taken by the bystanding buyer accounts during Step B through Step J. Each of the bystanding buyer accounts is prompted to select desired settings from the plurality of automated setting through the corresponding PC device. The desired settings include, but are not limited to, recording transaction history, recording product metadata, and price thresholds for purchasing products. The desired settings are executed for each of the bystanding buyer accounts with the remote server during Steps B through Step J. The execution of the desired settings promotes products and similar products that the user bought through previous transactions or previously viewed the through the recorded metadata. The price threshold is a value received by the remote server for the negotiation feedback during Step F, such that the transaction is completed if the quoted price is equal to or less than the price threshold. The price threshold is dynamically dependent on the transaction history and the quoted prices in order to be most profitable to the user of the bystanding buyer account.

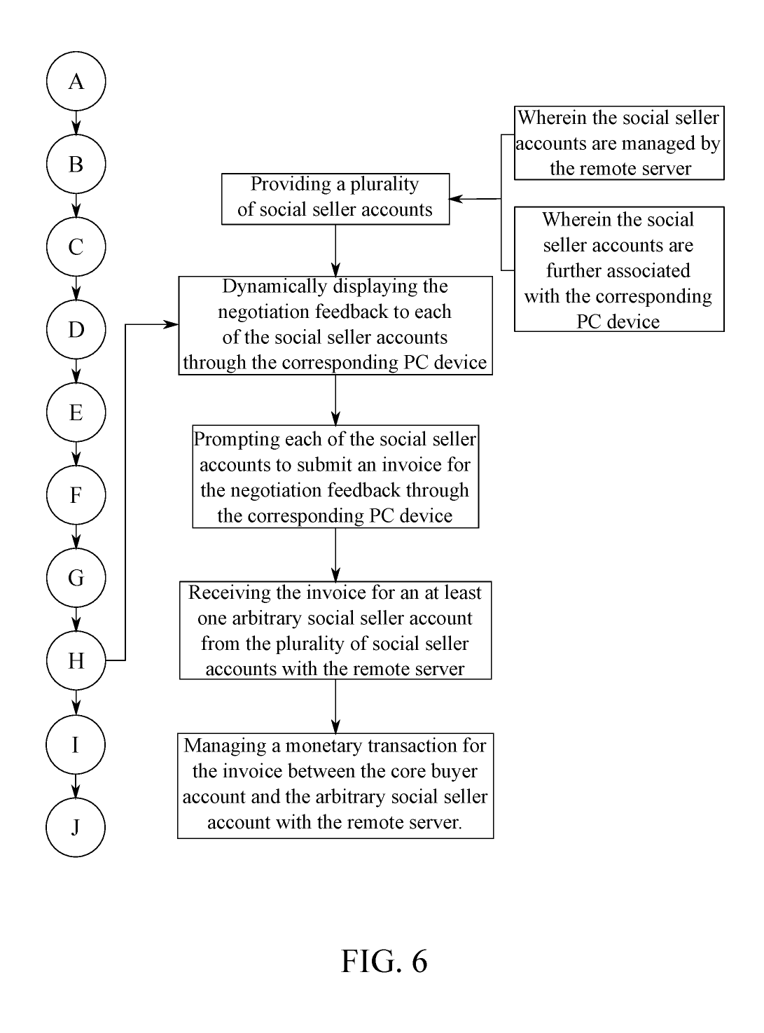

In some embodiments of the present invention, a plurality of social seller accounts is provided, wherein the social seller accounts are managed by the remote server, in accordance to FIG. 6. The social seller accounts are further associated with the corresponding PC device. The social seller accounts are merchants who are not participating directly in negotiations between the core buyer accounts and the seller account. The social sellers are individuals or organizations that provide services that facilitate and improve a transaction process for both buyers and sellers. For example, social sellers can be tasked with promoting an ongoing or future transaction with other potential buyers in order to integrate them with the core buyer accounts. The negotiation feedback is dynamically displayed to each of the social seller accounts through the corresponding PC device in order for the social seller accounts to assess the value of the product during Step H. Next, each of the social seller accounts is prompted to submit an invoice for the negotiation feedback through the corresponding PC device in order to set a price for a future product demand. The invoice for at least one arbitrary social seller account from the plurality is then received with the remote server such that the at least one arbitrary social seller account is able to organize future transactions. A monetary transaction for the invoice is finally managed between the core buyer account and the arbitrary social seller account with the remote server.

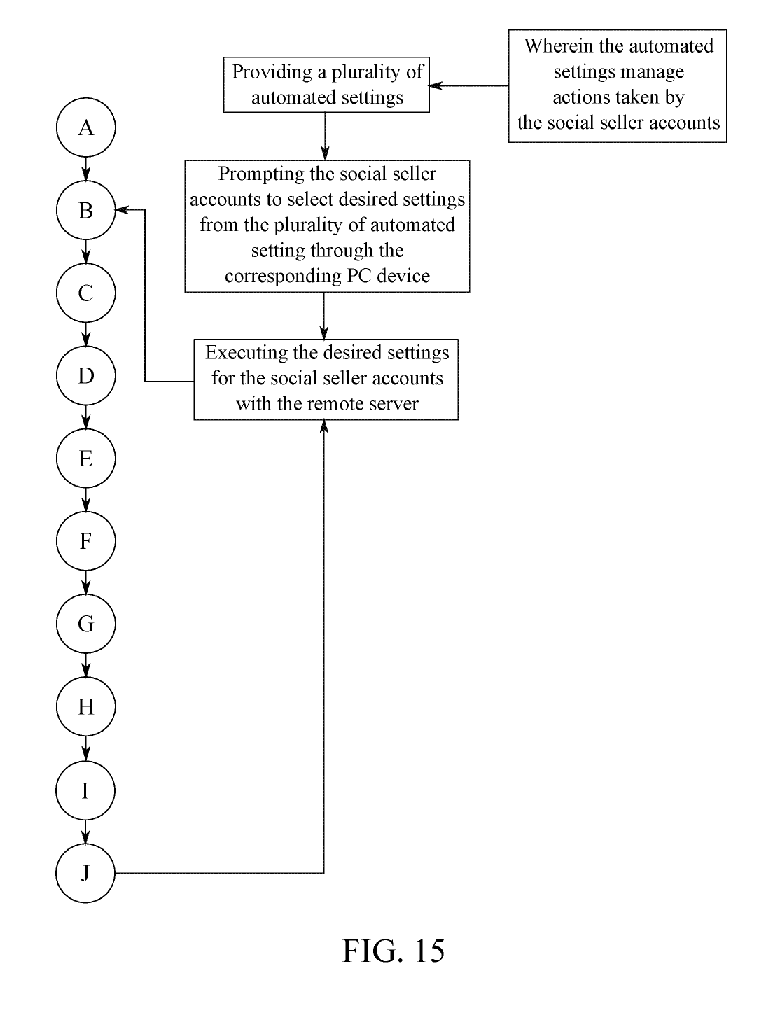

Similar to the seller account, the automated settings allow users of the social seller accounts to manage the purchasing transaction through the use of a dynamic artificial intelligence, as shown in FIG. 15. The automated settings manage actions taken by the social seller accounts during Step B through Step J. The social seller accounts are prompted to select desired settings from the plurality of automated setting through the corresponding PC device. The desired settings include, but are not limited to, recording transaction history, recording product metadata, and price thresholds for selling products. The desired settings are executed for the seller accounts with the remote server during Steps B through Step J. The execution of the desired settings promotes products and similar products that the user bought through previous transactions or previously viewed the through the recorded metadata. The price threshold is a value received by the remote server for the quoted price during Step F, such that the transaction is completed if the negotiation feedback is equal to or greater than the price threshold. The price threshold is dynamically dependent on the transaction history and the negotiation feedback in order to be most profitable to the users of the social seller accounts.

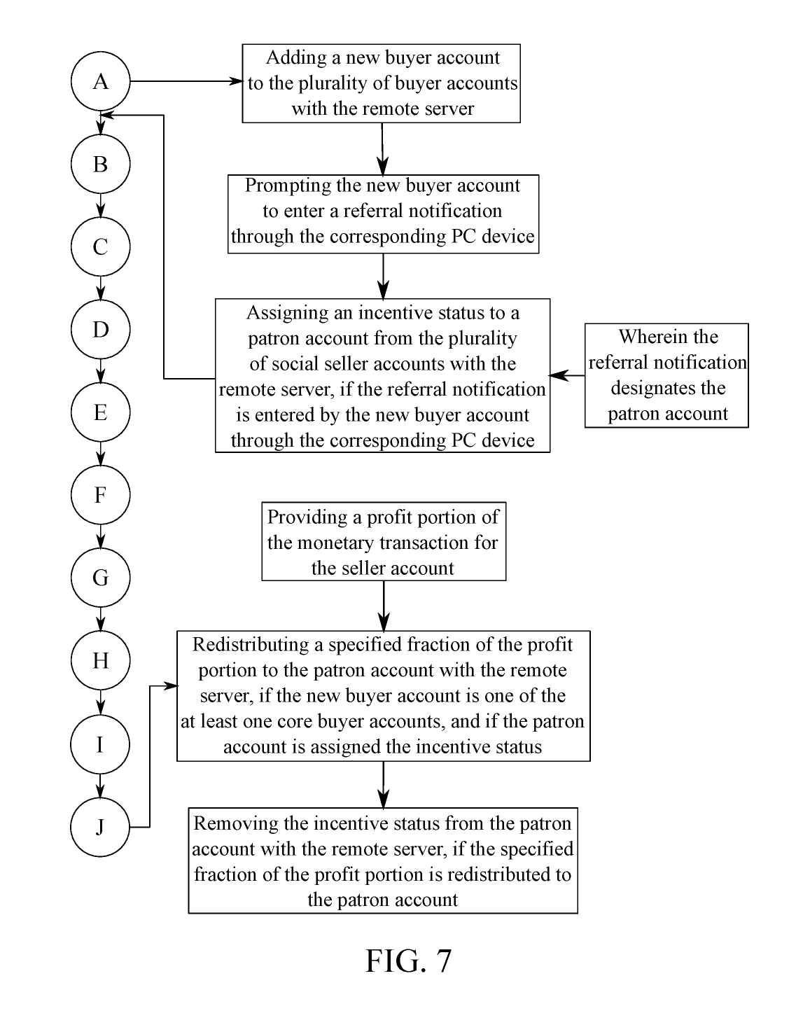

Similar to the core buyer accounts, the social seller accounts aim to draw new buyers into the core buyer accounts, in accordance to FIG. 7. As previously mentioned, a new buyer account is added to the plurality of buyer accounts with the remote server during step A. The new buyer account is prompted to enter a referral notification through the corresponding PC device. An incentive status is assigned to a patron account from the plurality of social seller accounts with the remote server, if the referral notification is entered by the new buyer account through the corresponding PC device, wherein the referral notification designates the patron account. Thus, the patron account is recognized for bringing new buyers into the present invention and, therefore, eligible to receive compensation for bringing new accounts into the present invention.

In some embodiments, the compensation for a patron account from the plurality of social seller accounts is monetary and results from the transaction between the buyer accounts and the seller account. A specified portion of the profit portion is redistributed to the patron account with the remote server during step J, if the new buyer account is one of the at least one core buyer accounts and if the patron account is assigned the incentive status. The remainder of the profit portion is distributed to the seller account such that the seller account receives payment for the transfer of the goods and services provided. The incentive status is removed from the patron account with the remote server, if the specified fraction of the profit portion is redistributed to the patron account, such that the present invention recognizes the patron account has been compensated for the referral.

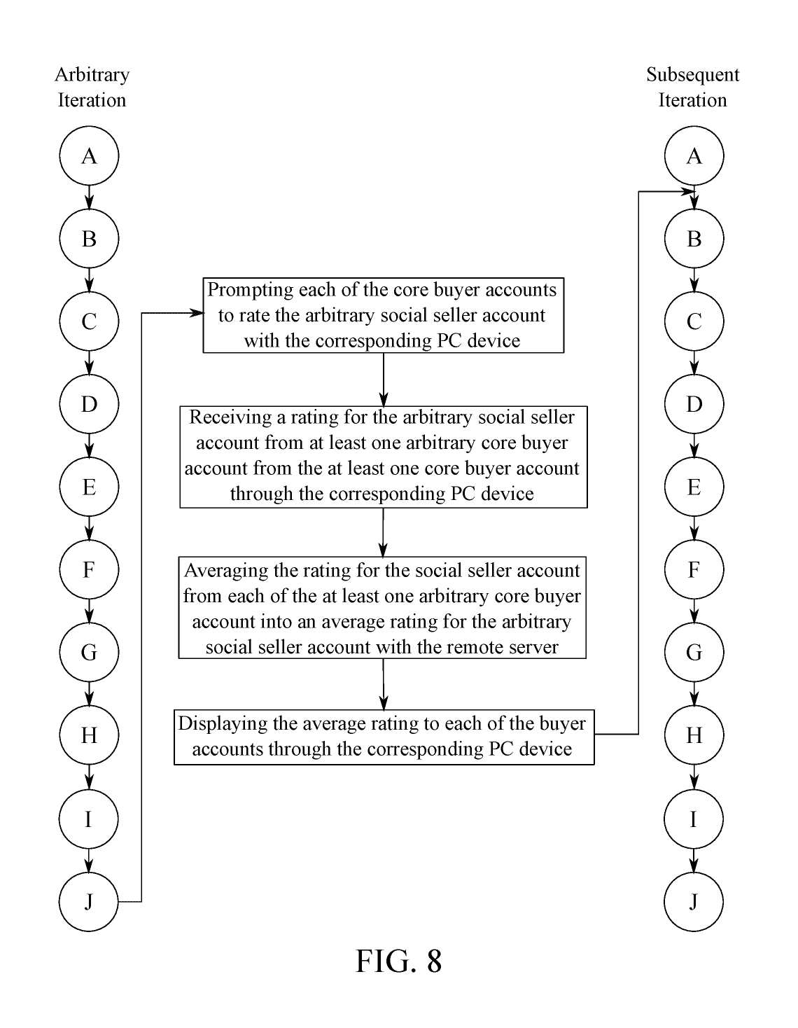

In some embodiments of the present invention, the social seller accounts are rated by the buyer accounts in order to show reliability and trustworthiness of the social seller accounts to prevent scamming as well as, to maintain high quality transactions. As shown in FIG. 8, each of the core buyer accounts is prompted to rate the arbitrary social seller account with the corresponding PC device. A rating is received for the arbitrary social seller account from at least one arbitrary core buyer account from the at least one core buyer account through the corresponding PC device. The rating is a quantitative means for displaying the reliability and trustworthiness of the arbitrary social seller account. The rating for the social seller account from each of the at least one arbitrary core buyer accounts is averaged into an average rating for the arbitrary social seller account with the remote server. The average rating is then displayed to each of the buyer accounts through the corresponding PC device, in order to inform each of the buyer accounts of the reputation of the arbitrary seller account.

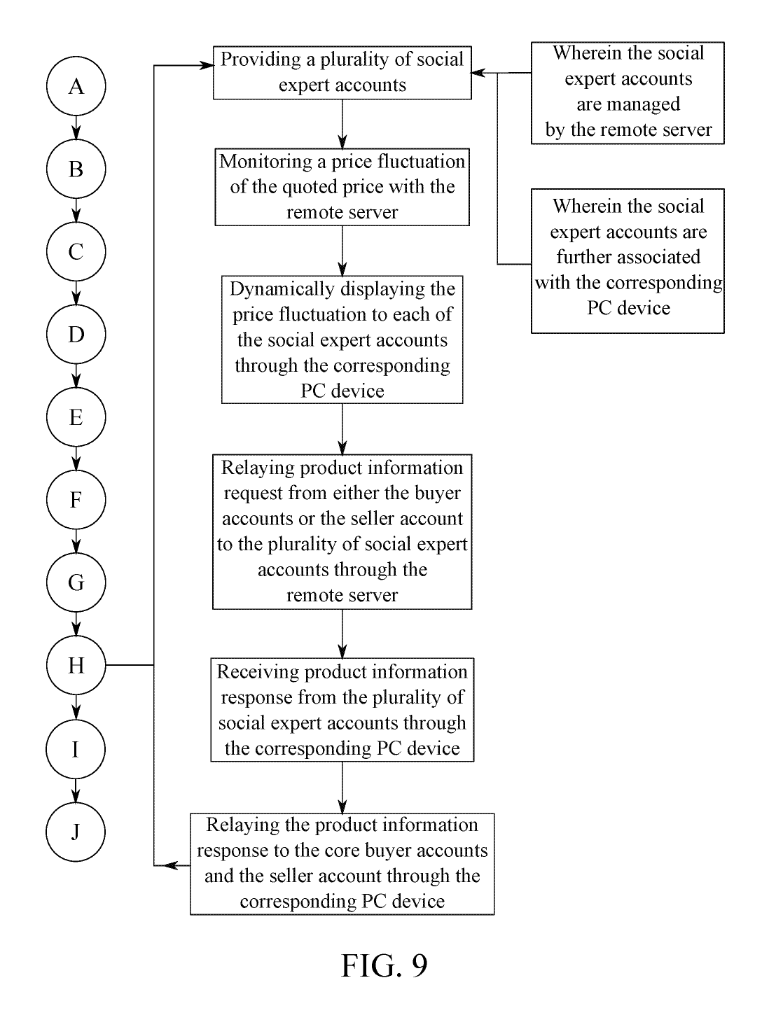

In some embodiments of the present invention, the remote server additionally manages a plurality of social expert accounts, wherein the social expert accounts are further associated with the corresponding PC device. Users of the social expert accounts are, typically, individuals or organizations with specialized knowledge in the various fields and types of products or services. The social expert accounts are able to provide consultation and assists to both the buyer accounts and the seller account in order for the buyer accounts and the seller account to make informed decisions regarding the transaction. The social expert accounts are not directly involved in the transaction between the buyer accounts and the seller account but may be called upon for assistance. In accordance to FIG. 9, a price fluctuation of the quoted price is monitored with the remote server during Step H. The price fluctuation is dynamically displayed to each of the social expert accounts through the corresponding PC device. A product information request is relayed to the plurality of social expert accounts through the remote server from either the buyer accounts or the seller account. The product information request allows the users of the buyer accounts or the seller account to receive insight on the value of a product based on quality of the product or insight through expertise in the field of the product. Once the product information request is received by the social expert accounts, the social expert accounts are able to submit a product information response with regards to the information the social seller is prompted for by the buyer accounts or the seller account. The product information response includes the consultation from the user of the social expert account. The product information response is received from the plurality of social expert accounts through the corresponding PC device. The product information response is relayed to the core buyer accounts and the seller account, respectively, through the corresponding PC device during Step H, such that the core buyer accounts and the seller account are able to make informed purchasing and selling decisions.

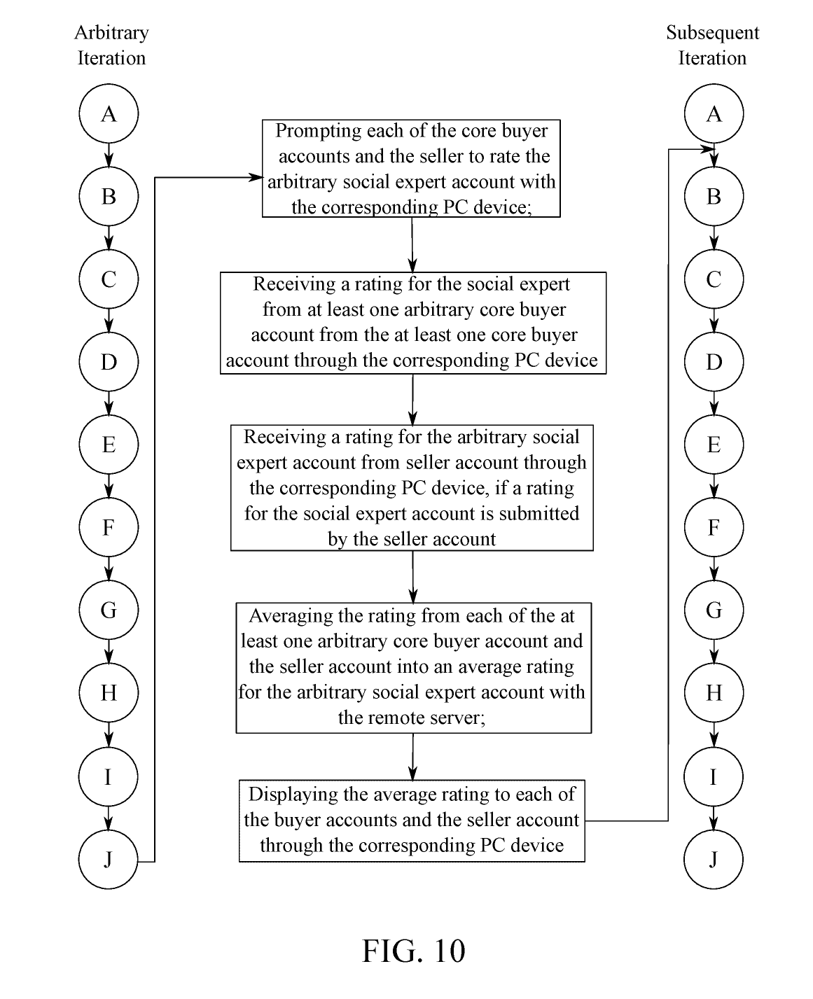

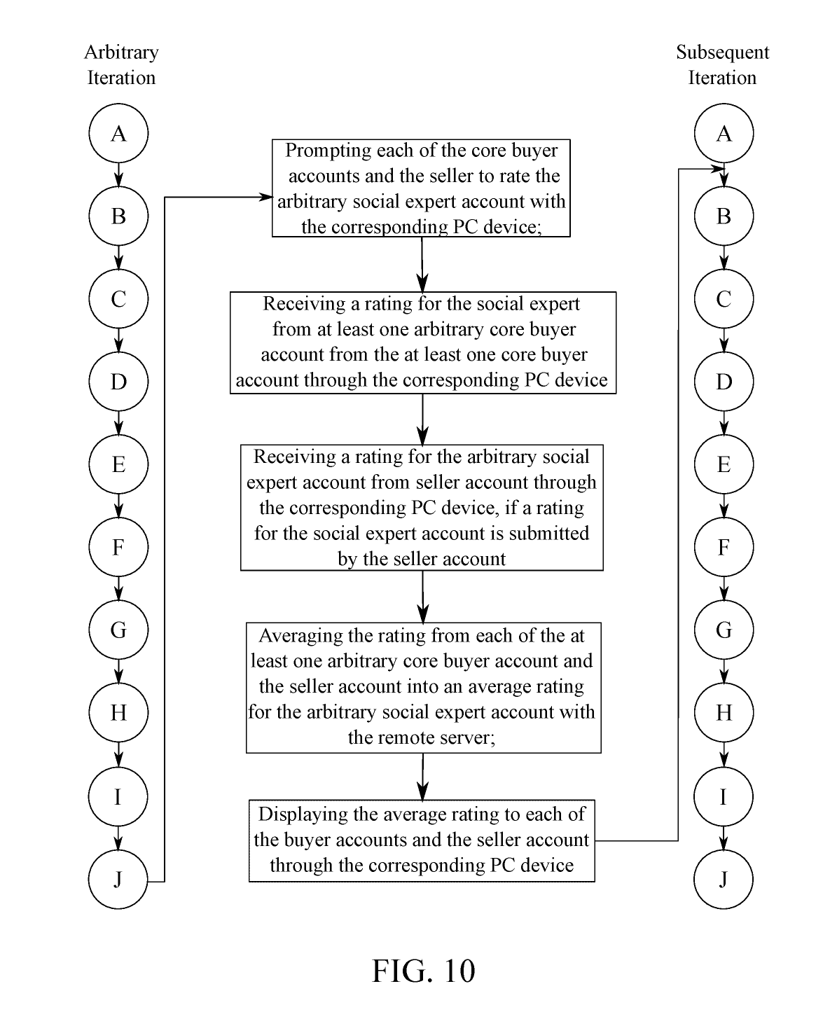

In some embodiments, each of the social expert accounts are rated in order to inform the buyer accounts and the seller account that the social expert account is knowledgeable and trustworthy with regards for the product information the social expert account provides. As detailed in FIG. 10, each of the core buyer accounts and the seller account are prompted to rate an arbitrary social seller account, with the corresponding PC such that the rating reflects the satisfaction of the product information provided. A rating for the arbirtary social expert from at least one arbitrary core buyer account from the at least one core buyer account is received through the corresponding PC device. Similarly, a rating for the social expert is received from the seller account through the corresponding PC device, if the rating for the arbitrary social expert is submitted by the seller account. The rating from each of the at least one arbitrary core buyer accounts and the seller account are averaged into an average rating for the arbitrary social expert account with the remote server. Similar to displaying the rating for the social seller, the average rating is displayed to each of the buyer accounts and seller account through the corresponding PC device in order for the buyer accounts and the seller accounts to make informed decisions as to which social sellers to prompt for reliable product information.

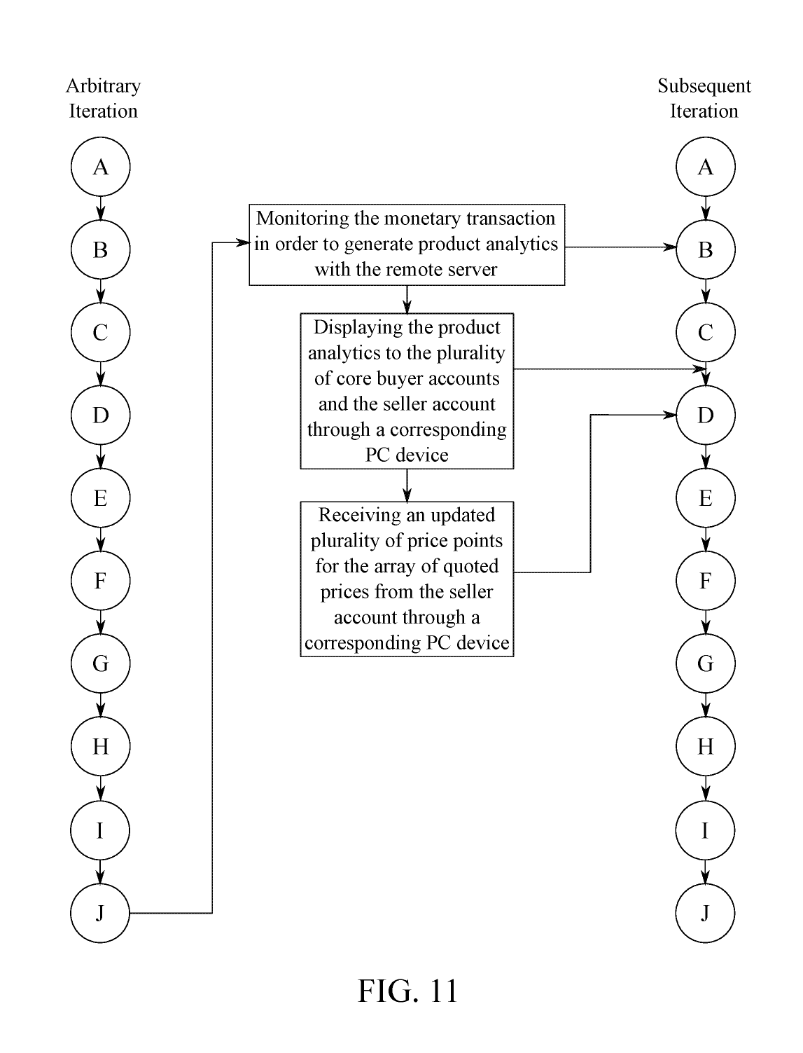

In still other embodiments of the present invention, the present invention is able to track product trends price fluctuations. In accordance to FIG. 11, the multiple monetary transactions are monitored through multiple iterations of Steps B to J in order to generate product analytics with the remote server. Product analytics help the buyer accounts and the seller account to see trends in the product history, demographics, ratings, and reviews to make informed transaction decisions with knowledge of such trends. The product analytics are displayed to the plurality of core buyer accounts and the seller account through the corresponding PC device prior to Step D. In a more specific embodiment, an updated plurality of price points for the array of quoted prices is received from the seller account through the corresponding PC device during step D, as the seller account would be better informed from viewing the product analytics.

Although the invention has been explained in relation to its preferred embodiment, it is to be understood that many other possible modifications and variations can be made without departing from the spirit and scope of the invention as hereinafter claimed.

What is claimed is:

1. A method of negotiating prices and distributing products and services comprises the steps of:
(A) providing a plurality of buyer accounts and a seller account, wherein the buyer accounts and the seller account are managed by at least one remote server, and wherein each of the buyer accounts and the seller account are associated with a corresponding personal computing (PC) device;
(B) receiving an at least one future product demand notification from an at least one core buyer account through the corresponding PC device, wherein the core buyer account is any one of the plurality of buyer accounts;
(C) displaying the future product demand notification to the seller account through the corresponding PC device;
(D) receiving an array of quoted prices for the future product demand from the seller account through the corresponding PC device;
(E) displaying the array of quoted prices for future product demand to each of the buyer accounts through the corresponding PC device;
(F) receiving negotiation feedback for a quoted price from the array of quoted prices for future product demand from the core buyer account by the remote server through the corresponding PC device;
(G) displaying the negotiation feedback for the quoted price to the seller account through the corresponding PC device;
(H) managing iterations of steps (D) through (G) with the remote server, until the quoted price is quantitatively equal to the negotiation feedback;
(I) designating the quoted price as a final price point for future product demand with the remote server; and
(J) managing a monetary transaction for the final price point for future product demand between the core buyer account and the seller account with the remote server.

2. The method of negotiating prices and distributing products and services, as claimed in claim 1, comprises the step of:
generating a shipping order for the future product demand with the remote server after step (J).

3. The method of negotiating prices and distributing products and services, as claimed in claim 1, comprises the steps of:
providing a plurality of automated settings, wherein the automated settings manage actions taken by the buyer accounts during steps (B) through (J);
prompting each of the buyer accounts to select desired settings from the plurality of automated setting through the corresponding PC device;
executing the desired settings for each of the buyer accounts with the remote server during steps (B) through (J);

4. The method of negotiating prices and distributing products and services, as claimed in claim 1, comprises the steps of:
providing a plurality of automated settings, wherein the automated settings manage actions taken by the seller account during steps (B) through (J);
prompting the seller account to select desired settings from the plurality of automated setting through the corresponding PC device;
executing the desired settings for the seller account with the remote server during steps (B) through (J);

5. The method of negotiating prices and distributing products and services, as claimed in claim 1, comprises the steps of:
providing a product database, wherein the product database includes values for previous market transactions, current market prices, product demographics, manufacturing costs, and quality adjustments;
prompting the seller account to navigate through the product database with the corresponding PC device;
prompting the seller account to set the array of quoted prices for future product demand with the corresponding PC device; and
receiving an initial value for each price within the array of quoted prices for future product demand through the corresponding PC device prior to step (B).

6. The method of negotiating prices and distributing products and services, as claimed in claim 1, comprises the step of:
proportionately reducing the final price point for the future product demand based on a quantity of accounts within the at least one core buyer account with the remote server during step (I).

7. The method of negotiating prices and distributing products and services, as claimed in claim 1, comprises the steps of:
adding a new buyer account to the plurality of buyer accounts with the remote server during step (A);
prompting the new buyer account to enter a referral notification through the corresponding PC device; and
assigning an incentive status to a patron account from the plurality of buyer accounts with the remote server,
if the referral notification is entered by the new buyer account through the corresponding PC device, wherein the referral notification designates the patron account.

8. The method of negotiating prices and distributing products and services, as claimed in claim 5, comprises the steps of:
providing a profit portion of the monetary transaction for the seller account;
redistributing a specified fraction of the profit portion to the patron account with the remote server during step (J),
if the new buyer account is one of the at least one the core buyer account, and
if the patron account is assigned the incentive status; and
removing the incentive status from the patron account with the remote server,
if the specified fraction of the profit portion is redistributed to the patron account.

9. The method of negotiating prices and distributing products and services, as claimed in claim 1, comprises the steps of:
providing a plurality of bystanding buyer accounts, wherein the buyer accounts include the bystanding buyer accounts and the at least one core buyer account;
monitoring a price fluctuation of the quoted price with the remote server during step (H);
dynamically displaying the price fluctuation of the quoted price to each of the bystanding buyer accounts through the corresponding PC device;
prompting each of the bystanding buyer account to submit a current product demand notification through the corresponding PC device;
designating the price fluctuation at a current time as a final price point for current product demand with the remote server,
if the current product demand notification is submitted by an at least one arbitrary account from the plurality of bystanding buyer accounts; and
managing a monetary transaction for the final price point of current product demand with the remote server between the arbitrary account and the seller account.

10. The method of negotiating prices and distributing products and services, as claimed in claim 9, comprises the steps of:
providing a plurality of automated settings, wherein the automated settings manage actions taken by the bystanding buyer accounts during steps (B) through (J);
prompting each of the bystanding buyer accounts to select desired settings from the plurality of automated setting through the corresponding PC device;
executing the desired settings for each of the bystanding buyer accounts with the remote server during steps (B) through (J);

11. The method of negotiating prices and distributing products and services, as claimed in claim 1, comprises the steps of:
providing a plurality of social seller accounts, wherein the social seller accounts are managed by the remote server and wherein the social seller accounts are further associated with the corresponding PC device;
dynamically displaying the negotiation feedback to each of the social seller accounts through the corresponding PC device during step (H);
prompting each of the social seller accounts to submit an invoice for the negotiation feedback through the corresponding PC device;
receiving the invoice for an at least one arbitrary social seller account from the plurality of social seller accounts with the remote server; and
managing a monetary transaction for the invoice between the core buyer account and the arbitrary social seller account with the remote server.

12. The method of negotiating prices and distributing products and services, as claimed in claim 11, comprises the steps of:
providing a plurality of automated settings, wherein the automated settings manage actions taken by the social seller account during steps (B) through (J);
prompting the seller account to select desired settings from the plurality of automated setting through the corresponding PC device;
executing the desired settings for the seller account with the remote server during steps (B) through (J);

13. The method of negotiating prices and distributing products and services, as claimed in claim 12, comprises the steps of:
providing a profit portion of the monetary transaction for the seller account;
adding a new buyer account to the plurality of buyer accounts with the remote server during step (A);
prompting the new buyer account to enter a referral notification through the corresponding PC device;
assigning an incentive status to a patron account from the plurality of social seller accounts with the remote server,
if the referral notification is entered by the new buyer account through the corresponding PC device, wherein the referral notification designates the patron account;
redistributing a specified fraction of the profit portion to the patron account with the remote server during step (J),
if the new buyer account is one of the at least one core buyer accounts, and
if the patron account is assigned the incentive status; and
removing the incentive status from the patron account with the remote server,
if the specified fraction of the profit portion is redistributed to the patron account.

14. The method of negotiating prices and distributing products and services, as claimed in claim 12, comprises the steps of:
prompting each of the core buyer accounts to rate the arbitrary social seller account with the corresponding PC device;
receiving a rating for the arbitrary social seller account from at least one arbitrary core buyer account from the at least one core buyer account through the corresponding PC device;
averaging the rating for the social seller account from each of the at least one arbitrary core buyer account into an average rating for the arbitrary social seller account with the remote server; and
displaying the average rating to each of the buyer accounts through the corresponding PC device.

15. The method of negotiating prices and distributing products and services, as claimed in claim 1, comprises the steps of:
providing a plurality of social expert accounts, wherein the social expert accounts are managed by the remote server, and wherein the social expert accounts are further associated with the corresponding PC device;
monitoring a price fluctuation of the quoted price with the remote server during step (H);
dynamically displaying the price fluctuation to each of the social expert accounts through the corresponding PC device; and
relaying product information request from either the buyer accounts or the seller account to the plurality of social expert accounts through the remote server.

16. The method of negotiating prices and distributing products and services, as claimed in claim 15, comprises the steps of:
receiving product information response from the plurality of social expert accounts through the corresponding PC device; and
relaying the product information response to the core buyer accounts and the seller account through the corresponding PC device during step (H).

17. The method of negotiating prices and distributing products and services, as claimed in claim 15, comprises the steps of:
prompting each of the core buyer accounts and the seller to rate the arbitrary social expert account with the corresponding PC device;
receiving a rating for the arbitrary social expert from at least one arbitrary core buyer account from the at least one core buyer account through the corresponding PC device;
receiving a rating for the social expert account from seller account through the corresponding PC device,
if a rating for the social expert account is submitted by the seller account;
averaging the rating from each of the at least one arbitrary core buyer account and the seller account into an average rating for the arbitrary social expert account with the remote server; and
displaying the average rating to each of the buyer accounts and the seller account through the corresponding PC device.

18. The method of negotiating prices and distributing products and services, as claimed in claim 1, comprises the steps of:
monitoring the monetary transaction through multiple iterations of steps (B) to (J) in order to generate product analytics with the remote server; and
displaying the product analytics to the plurality of core buyer accounts and the seller account through a corresponding PC device prior to step (D).

19. The method of negotiating prices and distributing products and services, as claimed in claim 18, comprises the step of:
receiving an updated plurality of price points for the array of quoted prices from the seller account through a corresponding PC device during step (D).
